(19) United States
(12) Patent Application Publication
(10) Pub. No.: US 2026/0058955 A1
(43) Pub. Date: Feb. 26, 2026

(54) SYSTEMS AND METHODS FOR ACCESS GRAPH

(71) Applicant: Palantir Technologies Inc., Denver, CO (US)

(72) Inventors: Kevin Lowe, New York, NY (US); Hubert Chan, Palo Alto, CA (US)

(21) Appl. No.: 19/043,181

(22) Filed: Jan. 31, 2025

Related U.S. Application Data
(60) Provisional application No. 63/687,061, filed on Aug. 26, 2024.

(51) Int. Cl. H04L 9/40

(52) U.S. Cl. CPC H04L 63/105; H04L 63/102

(57) ABSTRACT

In some examples, systems and methods for presenting access information are provided. For example, a method includes: receiving an indication of an entity, the entity being associated with one or more resource entities and one or more access entities; determining one or more permission relationships and one or more member relationships associated with the entity; generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes.

This application claims priority U.S. Provisional Application No. 63/687,061, filed Aug. 26, 2024, which is incorporated in its entirety by reference herein for all purposes.

### FIELD

Certain embodiments of the present disclosure relate to managing and/or checking data access. More particularly, some embodiments of the present disclosure relate to presenting data access (e.g., complex data access).

### BACKGROUND

Organizations often use computing systems and/or platforms to solve real-world problems. During the process, in examples, the computing systems and/or platforms often generate, access, and/or manage large amount of data. In some embodiments, data from different data sources may have different data access requirements.

Hence, it is desirable to improve techniques for managing, checking, and presenting data access.

### SUMMARY

Certain embodiments of the present disclosure relate to managing and/or checking data access. More particularly, some embodiments of the present disclosure relate to presenting data access (e.g., complex data access).

At least some embodiments are directed to a method for access graphing. In certain embodiments, the method includes: receiving an indication of an entity to be represented as a node in an access graph, the entity being associated with one or more resource entities and one or more access entities; determining one or more permission relationships associated with the entity and the one or more resource entities; determining one or more member relationships associated with the entity and the one or more access entities; generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and causing presenting a representation of the access graph; wherein the method is performed by one or more processors.

At least some embodiments are directed to a system for access graphing, the system comprising: one or more memories comprising instructions stored thereon; and one or more processors configured to execute the instructions and perform operations comprising: receiving an indication of an entity to be represented as a node in an access graph, the entity being associated with one or more resource entities and one or more access entities; determining one or more permission relationships associated with the entity and the one or more resource entities; determining one or more member relationships associated with the entity and the one or more access entities; generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and causing presenting a representation of the access graph.

At least some embodiments are directed to a non-transitory computer-readable storage medium having instructions for access graphing that, when executed by one or more processors, cause the one or more processors to perform operations comprising: receiving an indication of an entity to be represented as a node in an access graph, the entity being associated with one or more resource entities and one or more access entities; determining one or more permission relationships associated with the entity and the one or more resource entities; determining one or more member relationships associated with the entity and the one or more access entities; generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and causing presenting a representation of the access graph.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1A and FIG. 1B is a simplified diagram showing a method for access graphing according to certain embodiments of the present disclosure.

FIG. 2 is a simplified diagram showing a method for generating and/or updating an access management software using an AI model according to certain embodiments of the present disclosure.

FIG. 3 is an illustrative access management environment according to certain embodiments of the present disclosure.

FIG. 4 is an illustrative data diagram of entities and relationships according to certain embodiments of the present disclosure.

FIGS. 5A and 5B are example user interfaces showing example access graphs according to certain embodiments of the present disclosure.

FIG. 6 is a simplified diagram showing a computing system for implementing a system for access management in accordance with at least one example set forth in the disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any number within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods often check and present data access by looking into individual resources. In some examples, traditional access control models have limitations in handling the increasing complexity and scale of user permissions and object hierarchies in software applications. For example, for a software application (e.g., a dashboard application) referencing multiple resources across several data repositories, conventional systems and methods often cannot present permission information of a user and/or a group across the multiple resources and data repositories as referenced by the software application. Additionally, conventional systems and methods are often lack of a way to manage complex access control (e.g., permission, security) permissions and access controls efficiently and reliably.

Various embodiments of the present disclosure can achieve benefits and/or improvements by using an access management system (e.g., software module) to manage, and/or present data access of a software system including various access control types (e.g., role-based access control, attribute-based access control, classification-based access control, etc.) and various resources (e.g., tens or hundreds of data resources). In certain embodiments, the access management system can greatly improve efficiency in checking access and presenting access permissions across various resources, for example, using an access graph.

According to some embodiments, an access graph includes one or more nodes representing entities and one or more edges representing permissions and/or relationships. In certain embodiments, an entity can be an access entity, a resource entity, a permission entity, and/or the like. In certain embodiments, an access entity refers to an entity requesting access to one or more resources (e.g., data resources, software projects, files, folders, data repositories, etc.). In some examples, an access entity can be a user and/or an access group. In some embodiments, the system can use an access group to manage resource accesses. In certain embodiments, a user is an access group. For example, a user identifier is a group identifier. In some embodiments, an access group includes one or more members, where each member can be a real user, a virtual user, an access group, and/or the like. In certain embodiments, the user is a member of an access group. In some embodiments, an access permission of the user is inherited from the access group. In certain embodiments, an access management system uses one or more access levels for hierarchical relationships between access entities. For example, a first access entity (e.g., a user, an access group, etc.) is at a first access level and a second access entity (e.g., a user, an access group, etc.) is at a second access level, where the second access entity is a member of the first access entity.

According to certain embodiments, a resource entity is a digital entity, for example, a software project, a software application, an instance of a software application, a file, a folder, a dataset, a data source, a data repository, an object, and/or the like. In some examples, a data source includes data collected by one or more hardware devices (e.g., sensors). In certain examples, a data source includes data stored in a data repository. In some embodiments, a first resource entity references a second resource entity, also referred to as a component. For example, a first resource entity is a dashboard software application referencing five different data repositories, each a second resource entity, which can be on different physical servers or hardware, or can be in different virtual tenants. In some embodiments, the first resource entity is at a first resource level and the second resource entity is at a second resource level.

According to some embodiments, a permission entity includes one or more requirements for accessing a resource. In certain embodiments, the permission entity is an organization entity including one or more organization requirements (e.g., a specific organization, etc.). In some embodiments, the permission entity is a marking entity including one or more marking requirements. According to certain embodiments, a resource entity (e.g., a digital entity, a data resource, a software application, etc.), also referred to as a resource, requires access (e.g., references) to a plurality of other resource entities (e.g., data resources, software applications), also referred to as components. In some examples, a resource entity is associated with one or more permission entities (e.g., one or more marking entities, one or more organization entities, etc.). In some examples, a marking entity, also referred to as a marking, corresponds to at least one selected from a group consisting of a sensitivity level, a training level, a user type, and an organization type. For example, a user may be unable to access resources with a particular marking unless the user has a sensitivity clearance that satisfies the sensitivity level of the particular marking. As an example, a user may be unable to access resources with a particular marking unless the user has certain training that satisfies the training level of the particular marking. As an example, a user may be unable to access resources with a particular marking unless the user has a certain title that satisfies the user type of the particular marking. As an example, a user may be unable to access resources with a particular marking unless the user is part of a certain organization that satisfies the organization type of the particular marking.

According to some embodiments, an access entity can have one or more marking relationships for a marking entity. In some examples, the marking relationship can be an administrator, an applier, a remover, a member, and/or the like. As an example, an administrator can administrate the use of a marking, for example, add, change, and/or delete a marking entity from one or more resource entities. For example, an applier can apply the marking to one or more resources. As an example, a remover can remove the marking from one or more resources. For example, a member satisfies the criteria associated with the marking.

According to certain embodiments, the access graph includes one or more edges connecting one or more nodes. In some embodiments, the access graph is a multigraph having two nodes are connected by two different edges (e.g., one representing viewer, one representing inherited). In certain embodiments, the one or more edges include one or more permission edges representing one or more permission relationships, which indicate whether an access entity can access a resource entity and what limitation applies (e.g., a role-based limitation). In some embodiments, the one or more edges include one or more membership edges representing one or more member relationships (e.g., a member, a parent, etc.). In certain embodiments, the one or more edges include one or more control edges representing one or more control relationships (e.g., organization relationships, marking relationships, etc.). In some embodiments, the one or more edges can include other edges representing other relationships.

According to certain embodiments, a permission relationship can represent or use a role-based access control. In some embodiments, the role-based access control refers to an approach to restricting data, resource, and/or system access to permitted users by roles, where different roles have different privileges and responsibilities. In certain embodiments, a role (e.g., an owner, an editor, a viewer, a discoverer, etc.) is essentially a collection of permissions, and users receive permissions through the roles to which they are assigned, or through roles inherited through the role hierarchy. For example, a discoverer can only see names and metadata of resources (e.g., files, datasets, data tables, data structures, etc.), a viewer can view the content of datasets but cannot edit the files and cannot manage the resources' access control (e.g., permission, security), an editor can edit the resources and/or modify sharing property, and an owner can edit the datasets and has full control over the resources' access control (e.g., permission, security).

In some embodiments, the access management system can use an artificial intelligence (AI) model (e.g., a language model (LM), a large language model (LLM), etc.) to generate software code (e.g., in a programming language) for managing access controls, checking access controls, and/or generating explanations of access controls. In certain embodiments, the software code includes the functionality of adding permissions, changing permissions, and/or deleting permissions. In some embodiments, the software code can generate user interfaces presenting an access graph. In certain embodiments, the software code includes the functionality of adding a first access entity (e.g., a user, an access group) to a second access entity as a member, removing a member from an access entity, and/or the like. In some embodiments, the software includes the functionality of applying a permission entity (e.g., a marking entity, an organization entity, etc.) to a resource entity, removing a permission entity from a resource entity, changing a permission entity, creating a permission entity, deleting a permission entity, and/or the like.

According to certain embodiments, systems and methods address the problem of managing user permissions and access control in complex, multi-level systems with numerous resources. In such environments, for example, ensuring that users have appropriate access to data and resources while maintaining access control (e.g., permission, security) and compliance with regulatory requirements is a challenging task. In some examples, traditional access control models such as role-based access control (RBAC) and attribute-based access control (ABAC) face limitations in handling the increasing complexity and scale of user permissions and object hierarchies in software applications.

According to some embodiments, an access management system reasons with, simplifies and visualizes complex and hierarchical relationships between users, groups, resources, and permissions within an organization, for example, using an access graph. In certain embodiments, the access graph is a multigraph that represents the relationships between users, groups, resources, and permission controls. In some embodiments, nodes in the access graph represent users, groups, resources, and permissions, while edges represent the relationships and permissions between them.

According to certain embodiments, the access management system visualizes dissimilar entities on the same diagram, for example, users and groups, resources (e.g., digital entities), permission entities (e.g., markings, organizations, etc.), permissions, resulting consequences, and/or the like. In some embodiments, the access management system provides visualizations of access control (e.g., permission, security) and/or access controls. In certain embodiments, the access management system uses an access graph representing the relationships between entities. In some embodiments, the access management system uses an access graph visualizing complex, multiparent hierarchies and resolves redundant/duplicate relationships and nodes. In certain embodiments, the access management system uses an access graph that helps users traverse nested (e.g., transitive) relationships between entities with no limit on the tree traversal depth. In some embodiments, the access graph allows for the legibility of and distinction between explicit and implicit permissions. In certain embodiments, explicit permissions are those directly assigned to a user or group, while implicit permissions are those inherited through relationships in the graph. In some embodiments, the distinction between explicit permissions and implicit permissions allows for easier auditing and compliance monitoring. In certain examples, the permissions of a resource can be inherited, for example, from a parent or a grandparent.

According to some embodiments, in software platforms, managing access controls to different resources can be a complex and time-consuming task. For example, users and administrators need to ensure that only permitted personnel can access sensitive data. In certain embodiments, standard access authorization controls can include role-based access control (RBAC), attribute-based access control (ABAC), and/or classification-based access control. In some embodiments, a dataset can be from a single data source and/or stored at a single data repository. In certain embodiments, a dataset can be from a plurality of data sources and/or stored at a plurality of data repositories, for example, physically at different servers and/or at different repositories designated for different organizations (e.g., different tenants).

In some embodiments, the attribute-based access control refers to an approach to restricting data, resource, and/or system access to permitted users determined by evaluating attributes associated with the subject, object, requested operations, environment attributes, and/or the like. In certain embodiments, the classification-based access control refers to an approach to restricting data, resource and/or system access to permitted users (e.g., groups, users, etc.) by evaluating data classifications. In certain embodiments, there are no industry standard techniques and methods for reasoning across all such permutation of access controls for a given resource. In some embodiments, manually checking authorization can be inefficient and error-prone leading to legibility issues and operational delays in troubleshooting and extending access to resources. Therefore, in certain embodiments, an efficient and reliable way to check permissions for accessing data is needed.

According to certain embodiments, the present disclosure includes systems and methods for efficiently checking and presenting permissions for accessing different data and features within a software platform. In some embodiments, an access management system includes a permission management module (e.g., a central permission management module, an access management module) that stores and manages all the permissions and roles associated with different users and groups. In certain embodiments, the module is integrated with the authentication and authorization mechanisms of the platform, which ensures that only authenticated and permitted users can access the system.

According to some embodiments, the permission management module checks permissions for accessing different data and features within the platform. Instead of manually checking each permission for each user, in certain embodiments, the module uses a set of predefined rules and algorithms to determine the access rights of each user. In some embodiments, the rules take into account various factors such as user roles, group memberships, and data sensitivity levels, and generate a comprehensive and accurate set of permissions for each user. In certain embodiments, resource dependencies are traversed and resolved such that accurate access permission is generated (e.g., via displaying the policy).

According to certain embodiments, the access management system, also referred to as the data-access management system, can include one or more computing models (e.g., one or more artificial intelligence (AI) models), also referred to as resource access models, for generating and/or modifying one or more access parameters (e.g., configurations). In some embodiments, a model, also referred to as a computing model, includes a model to process data. A model includes, for example, an artificial intelligence (AI) model, a machine learning (ML) model, a deep learning (DL) model, an image processing model, an algorithm, a rule, other computing models, and/or a combination thereof. In certain embodiments, a resource access AI model can generate data access parameters for members, groups, users, organizations, projects, markings, and/or the like. In some embodiments, organizations can include one or more access groups.

In some embodiments, a resource access AI model includes a generative AI (artificial intelligence) model. In certain embodiments, a generative AI model is a type of AI model that can be used to produce various types of content, such as text, images, videos, audio, 3D (three-dimensional) data, 3D models, and/or the like. In some embodiments, a language model or a large language model (LLM), which is a type of generative AI model, includes content and training data embedded in the model.

According to some embodiments, the resource access AI model (e.g., a language model, an LLM, etc.) can be trained using selected corpus (e.g., historical access controls, historical access parameters, historical resource information, historical roles, historical classifications, historical permission attributes, historical markings, historical software code, etc.) and the resource access AI model is configured to generate software code (e.g., software code in python, etc.) for managing and/or checking access. In some embodiments, the resource access AI model includes a language model (“LM”) that may include an algorithm, rule, model, and/or other programmatic instructions that can predict the probability of a sequence of words or expressions (e.g., software code). In some embodiments, a language model may, given a starting text string (e.g., one or more words), predict the next word or expression in the sequence. In certain embodiments, a language model may calculate the probability of different word combinations and/or software code based on the patterns learned during training (based on a set of text data from books, articles, websites, audio files, software code, etc.).

In some embodiments, a language model may generate many combinations of one or more next words and/or expressions that are coherent and contextually relevant. In certain embodiments, a language model can be an advanced artificial intelligence algorithm that has been trained to understand, generate, and manipulate language (e.g., computing language expressions). In some embodiments, a language model can be useful for natural language processing, including receiving natural language prompts and providing natural language responses based on the text on which the model is trained. In certain embodiments, a language model may include an n-gram, exponential, positional, neural network, and/or other type of model. In some embodiments, a language model can be used to generate software code.

In certain embodiments, the resource access AI model includes a large language model (LLM), which was trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pretrained Transformer 3 (GPT-3) model, a GPT 3.5-turbo model, a Claude model, a command-xlang model, a bidirectional encoder representations from transformers (BERT) model, a pathways language model (PaLM) 2, and/or the like.

In some embodiments, the access management system can use the resource access AI model to generate software code (e.g., in a programming language), also referred to as an access control software, to manage and/or checking permission relationships, member relationships, and/or control relationships. In certain embodiments, the access control software can add permissions, change permissions, and/or delete permissions for an access entity (e.g., a user, a group). For example, the access control software can grant the permission to a resource to a user or remove the permission to the resource from the user. As an example, the access control software can apply a marking to a resource. In certain embodiments, the access control software includes the functionality of adding permissions, changing permissions, and/or deleting permissions. In some embodiments, the access control software can generate user interfaces presenting an access graph. In certain embodiments, the access control software includes the functionality of adding a first access entity (e.g., a user, an access group) to a second access entity as a member, removing a member from an access entity, and/or the like. In some embodiments, the access control software includes the functionality of applying a marking entity to a resource entity, removing a marking entity from a resource entity, changing a marking entity, creating a marking entity, deleting a marking entity, and/or the like.

According to some embodiments, the access management system includes an access explanation computing model. In some embodiments, the access explanation computing model can be trained using selected corpus (e.g., historical access controls, historical access parameters, historical resource information, historical permission controls, historical roles, historical classifications, historical software code, etc.). In certain embodiments, the access explanation computing model (e.g., an access explanation AI model) includes a language model that is trained to generate an explanation based on information associated with one or more components referenced by a resource for a user and/or a group of users. In certain embodiments, the access explanation computing model includes a large language model that is trained to generate an explanation based on information associated with one or more components referenced by a resource for a user and/or a group of users.

In some examples, the access explanation model is configured to generate an explanation including an indication of access, also referred to as permission, being permitted by at least one selected from a group consisting of a role-based access control, an attribute-based access control, and a classification-based access control. In certain examples, the access explanation model is configured to generate an explanation including an indication of access being denied by at least one selected from a group consisting of a role-based access control, an attribute-based access control, and a classification-based access control.

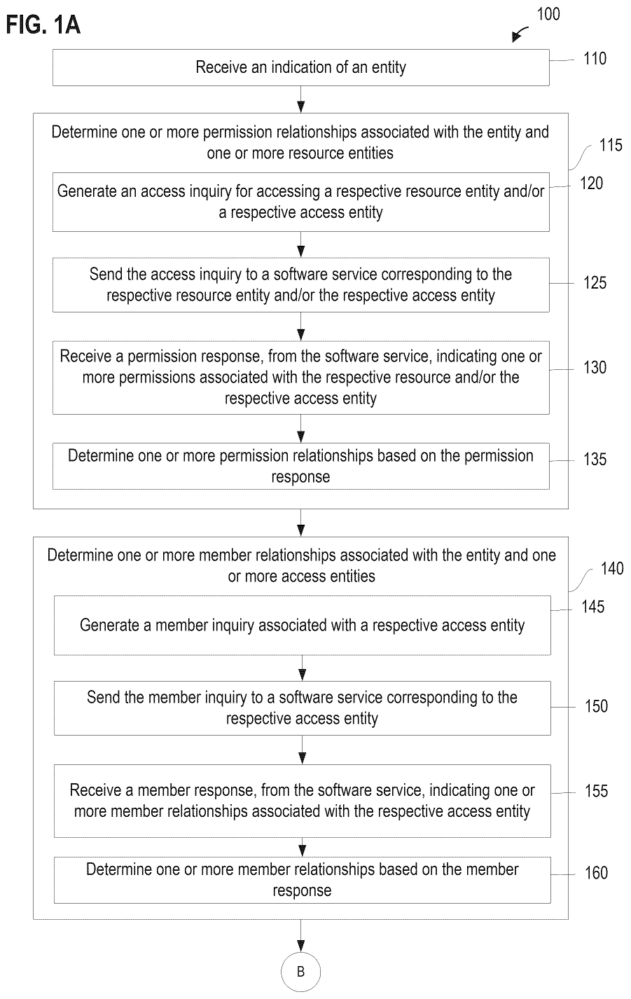

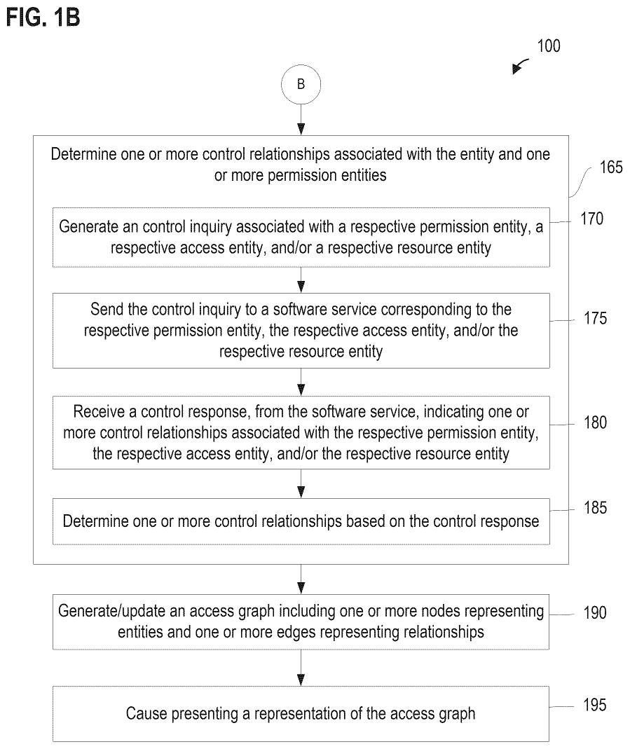

FIG. 1A and FIG. 1B is a simplified diagram showing a method 100 for access graphing according to certain embodiments of the present disclosure. This diagram is merely an example. One of ordinary skill in the art would recognize many variations, alternatives, and modifications. The method 100 for access graphing includes processes 110, 115, 120, 125, 130, 135, 140, 145, 150, 155, 160, 165, 170, 175, 180, 185, 190 and 195. Although the above has been shown using a selected group of processes for the method 100 for access graphing, there can be many alternatives, modifications, and variations. For example, some of the processes may be expanded and/or combined. Other processes may be inserted to those noted above. Depending upon the embodiment, the sequence of processes may be changed, and one or more processes may be replaced. Further details of these processes are found throughout the present disclosure.

In some embodiments, some or all processes (e.g., steps) of the method 100 are performed by a system (e.g., the computing system 600). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

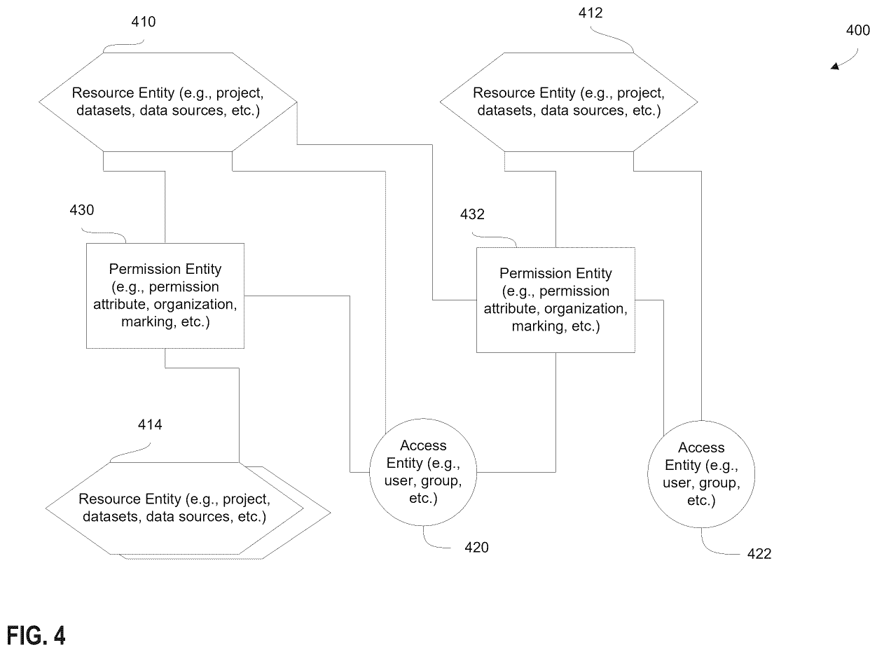

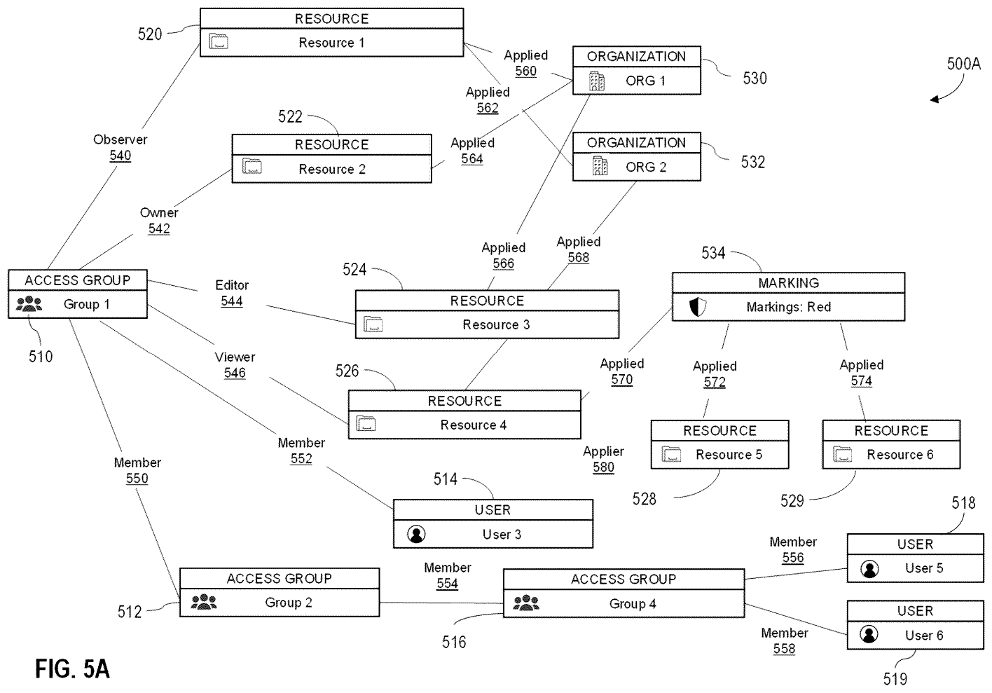

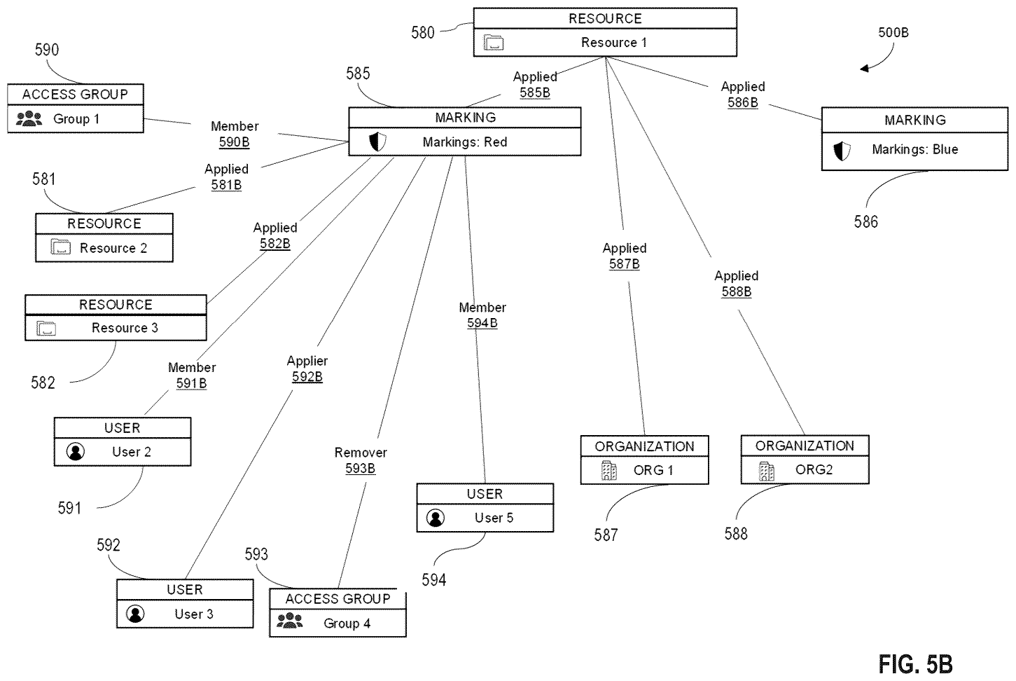

According to certain embodiments, at process 110, the system receives an indication of an entity. In some embodiments, the entity includes an access entity, for example, a user, an administrator, a virtual user, an access group, and/or the like. In certain embodiments, the entity includes a resource entity, for example, a project, a file, a folder, a dataset, and/or the like. In some embodiments, the entity includes a permission entity, for example, an organization, a marking, a permission requirement, and/or the like. FIG. 4 is an illustrative diagram shows the various types of entities. In some embodiments, the entity is to be represented as a node in an access graph. FIGS. 5A and 5B are some examples of access graphs.

In certain embodiments, the indication includes an identifier of the entity, a description of the entity, a name of the entity, and/or the like. In some embodiments, the system receives an indication of the entity from a user interface. In certain examples, the system receives an indication of the entity when a user selects to check the user's access graph or another user's access graph. In some examples, the system receives an indication of the entity from a software interface. In some embodiments, a software interface includes an application programming interface (API), a web service interface, retrieving information from a file, retrieving information from a data repository, and/or the like.

According to some embodiments, the system determines one or more relationships between two entities. In some embodiments, the one or more relationships include one or more permission relationships, one or more member relationships, one or more permission relationships, and/or the like.

According to certain embodiments, at process 115, the system determines one or more permission relationships associated with the entity and one or more resource entities. In certain embodiments, the entity is a first access entity, and the one or more permission relationships include one or more permission relationships between the first access entity and at least one of the one or more resource entities and/or one or more permission relationships associated with the first access entity. In some embodiments, the entity is a first resource entity and the one or more permission relationships include one or more permission relationships associated with the first resource entity. In certain embodiments, the entity is a first permission entity and the one or more permission relationships include one or more permission relationships associated with a resource entity and/or an access entity associated with the In some embodiments, a permission relationship indicates whether an access entity can access a resource entity and what limitation applies (e.g., a role-based limitation). In certain embodiments, the permission relationship can be of different access control types including, for example, a role-based access control (e.g., viewer, editor, etc.), an attribute-based access control (e.g., attributes of the access entity, attributes of the resource entity, etc.), a classification-based access control (e.g., classification of the resource entity), and/or the like. In some embodiments, the permission relationship can be an implicit permission relationship, for example, inherited from an access group. In certain embodiments, the permission relationship is an explicit permission relationship, for example, provided in the entity properties.

According to some embodiments, the system uses software services to determine the one or more permission relationships. In certain embodiments, the process 115 includes the processes 120-135. In some embodiments, at process 120, the system generates an access inquiry for accessing a respective resource entity and/or a respective access entity. In certain embodiments, the access inquiry includes a resource identifier associated with the respective resource entity and/or an identifier associated with the respective access entity. In some embodiments, at process 125, the system sends the access inquiry to a software service corresponding to the respective resource and/or the respective access entity. In certain embodiments, a software service refers to a software module that can run on a computing device. In certain embodiments, at process 130, the system receives a permission response from the software service, where the permission response indicates one or more permissions associated with the respective resource entity and/or a respective access entity. In some embodiments, at process 135, the system determines one or more permission relationships based on the permission response. In certain embodiments, the system can conduct processes 120-135 repeatedly to determine one or more additional permission relationships associated with other resource entities and/or access entities.

In some embodiments, the one or more permissions are all permissions associated with the respective resource entity (e.g., all access entities that are permitted to access the resource entity explicitly and/or implicitly). In certain embodiments, the one or more permissions are a part of all permissions associated with the respective resource entity. In some embodiments, the system receives an input indicating one or more criteria (e.g., having a marking), for example, from a user interface and/or a software interface. In certain embodiments, the system and/or the software service filters all permissions associated with the respective resource entity based on the one or more criteria to generate a set of filtered permission controls. In some embodiments, the input is in natural language and the system generates one or more filters using a computing model (e.g., an ML model, an AI model, etc.). In some embodiments, the system uses a language model (e.g., a large language model) to generate the one or more filters (e.g., software code, script, etc.).

In some embodiments, the one or more permissions are all permissions associated with the respective access entity (e.g., all resources permitted to be accessed by the access entity explicitly and/or implicitly). In certain embodiments, the one or more permissions are a part of all permissions associated with the respective access entity. In some embodiments, the system receives an input indicating one or more criteria (e.g., having a marking), for example, from a user interface and/or a software interface. In certain embodiments, the system and/or the software service filters all permissions associated with the respective resource entity based on the one or more criteria to generate a set of filtered permission controls. In some embodiments, the input is in natural language and the system generates one or more filters using a computing model (e.g., an ML model, an AI model, etc.). In some embodiments, the system uses a language model (e.g., a large language model) to generate the one or more filters (e.g., software code, script, etc.).

According to certain embodiments, at process 140, the system determines one or more member relationships associated with the entity and one or more access entities. In certain embodiments, the entity is a first access entity, and the one or more member relationships include one or more member relationships between the first access entity and at least one of the one or more access entities. In some embodiments, the entity is a first resource entity that can be accessed by an access entity and the one or more member relationships include one or more member relationships associated with the access entity. In certain embodiments, the entity is a first permission entity that is associated with an access entity (e.g., a marking role, an organization member, etc.) and the one or more member relationships include one or more member relationships associated with the access entity. In some embodiments, a member relationship indicates a relationship between two access entities including, for example, a member, a child group, a parent group, and/or the like.

According to some embodiments, the system uses software services to determine the one or more member relationships. In certain embodiments, the process 140 includes the processes 145-160. In some embodiments, at process 145, the system generates a member inquiry associated with a respective access entity. In certain embodiments, the access inquiry includes an identifier associated with the respective access entity. In some embodiments, at process 150, the system sends the member inquiry to a software service corresponding to the respective access entity. In certain embodiments, at process 155, the system receives a member response from the software service, where the permission response indicates one or more member relationships associated with the respective access entity. In some embodiments, at process 160, the system determines one or more member relationships based on the member response. In certain embodiments, the system can conduct processes 145-160 repeatedly to determine one or more additional member relationships associated with other access entities.

In some embodiments, the one or more member relationships are all member relationships associated with the respective access entity (e.g., all access entities that are members and/or parents of the access entity). In certain embodiments, the one or more permissions are a part of all member relationships associated with the respective access entity. In some embodiments, the system receives an input indicating one or more criteria (e.g., having a marking), for example, from a user interface and/or a software interface. In certain embodiments, the system and/or the software service filters all member relationships associated with the respective access entity based on the one or more criteria to generate a set of filtered member relationships. In some embodiments, the input is in natural language and the system generates one or more filters using a computing model (e.g., an ML model, an AI model, etc.). In some embodiments, the system uses a language model (e.g., a large language model) to generate the one or more filters (e.g., software code, script, etc.).

According to certain embodiments, at process 165, the system determines one or more control relationships associated with the entity and one or more permission entities. In certain embodiments, the entity is a first access entity, and the one or more control relationships include one or more control relationships between the first access entity and at least one of the one or more permission entities and/or one or more control relationships associated with the first access entity. For example, the one or more control relationships include one or more organization roles (e.g., a member, a non-member, etc.) and/or one or more marking roles (e.g., a member, an applier, an administrator, etc.) of the access entity. In some embodiments, the entity is a first resource entity and the one or more control relationships include one or more control relationships associated with the first resource entity (e.g., marking applied to the resource). In certain embodiments, the entity is a first permission entity and the one or more control relationships include one or more control relationships associated with the first permission entity. In some embodiments, a control relationship indicates whether an access entity has a role with a permission entity, and/or whether a resource entity is applied with the permission entity.

As an example, the first access control type is a role-based access control and the second access control type is an access control inherited from an access group. In certain embodiments, the system can use a marking to manage resource accesses. In some embodiments, the marking corresponds to at least one selected from a group consisting of a sensitivity level, a training level, a user type, and an organization type. For example, a user may be unable to access resources with a particular marking unless the user has a sensitivity clearance that satisfies the sensitivity level of the particular marking. As an example, a user may be unable to access resources with a particular marking unless the user has certain training that satisfies the training level of the particular marking. As an example, a user may be unable to access resources with a particular marking unless the user has a certain title that satisfies the user type of the particular marking. As an example, a user may be unable to access resources with a particular marking unless the user is part of a certain organization that satisfies the organization type of the particular marking.

According to some embodiments, the system uses software services to determine the one or more control relationships. In certain embodiments, the process 165 includes the processes 170-185. In some embodiments, at process 170, the system generates a control inquiry associated with a respective permission entity, a respective access entity, and/or a respective resource entity. In certain embodiments, the control inquiry includes a permission identifier associated with the respective permission entity, a resource identifier associated with the respective resource entity, and/or an identifier associated with the respective access entity. In some embodiments, at process 175, the system sends the control inquiry to a software service corresponding to the respective permission entity, the respective access entity, and/or the respective resource entity. In certain embodiments, at process 180, the system receives a control response from the software service, where the control response indicates one or more control relationships associated with the respective permission entity, the respective access entity, and/or the respective resource entity. In some embodiments, at process 185, the system determines one or more control relationships based on the control response. In certain embodiments, the system can conduct processes 160-185 repeatedly to determine one or more additional control relationships associated with other permission entities, resource entities and/or access entities.

In some embodiments, the one or more control relationships are all control relationships (e.g., applied resource entities) associated with the respective permission entity. In certain embodiments, the one or more control relationship are a part of all control relationships associated with the respective permission entity. In some embodiments, the system receives an input indicating one or more criteria (e.g., having a marking), for example, from a user interface and/or a software interface. In certain embodiments, the system and/or the software service filters all control relationships associated with the respective permission entity based on the one or more criteria to generate a set of filtered control relationships. In some embodiments, the input is in natural language and the system generates one or more filters using a computing model (e.g., an ML model, an AI model, etc.). In some embodiments, the system uses a language model (e.g., a large language model) to generate the one or more filters (e.g., software code, script, etc.).

In some embodiments, the one or more control relationships are all control relationships associated with the respective resource entity (e.g., permission entities applied, markings applied, etc.). In certain embodiments, the one or more control relationship are a part of all control relationships associated with the respective resource entity. In some embodiments, the system receives an input indicating one or more criteria (e.g., having a marking), for example, from a user interface and/or a software interface. In certain embodiments, the system and/or the software service filters all control relationships associated with the respective resource entity based on the one or more criteria to generate a set of filtered control relationships. In some embodiments, the input is in natural language and the system generates one or more filters using a computing model (e.g., an ML model, an AI model, etc.). In some embodiments, the system uses a language model (e.g., a large language model) to generate the one or more filters (e.g., software code, script, etc.).

In some embodiments, the one or more control relationships are all control relationships associated with the respective access entity (e.g., marking roles, organization relationships, etc.). In certain embodiments, the one or more control relationship are a part of all control relationships associated with the respective access entity. In some embodiments, the system receives an input indicating one or more criteria (e.g., having a marking), for example, from a user interface and/or a software interface. In certain embodiments, the system and/or the software service filters all control relationships associated with the respective access entity based on the one or more criteria to generate a set of filtered control relationships. In some embodiments, the input is in natural language and the system generates one or more filters using a computing model (e.g., an ML model, an AI model, etc.). In some embodiments, the system uses a language model (e.g., a large language model) to generate the one or more filters (e.g., software code, script, etc.).

According to certain embodiments, one or more access entities have different access levels based on the access graph. For example, a specific access entity is at a first access level (e.g., the primary access entity) for a first access graph, and is at a second access level for a second access graph, where the first access level is different from the second access level. In some embodiments, one or more resource entities have different resource levels based on the access graph. For example, a specific resource entity is at a first resource level (e.g., the primary resource entity) for a first access graph, and is at a second resource level for a second access graph, where the first resource level is different from the second resource level. In certain embodiments, one or more permission entities have different control levels based on the access graph. For example, a specific permission entity is at a first control level (e.g., the primary control entity) for a first access graph, and is at a second control level for a second access graph, where the first control level is different from the second control level.

In some embodiments, using the software services and parallel processing, the system can efficiently check and present permissions for accessing different data and features within a software platform. Accordingly, in certain embodiments, the system addresses the problem of managing user permissions and access control in complex, multi-level systems with numerous resources. In such environments, for example, ensuring that users have appropriate access to data and resources while maintaining access control (e.g., permission, security) and compliance with regulatory requirements is a challenging task.

FIG. 4 is an illustrative data diagram 400 of entities and relationships according to certain embodiments of the present disclosure. FIG. 4 is merely an example. One of ordinary skill in the art would recognize many variations, alternatives, and modifications. In some embodiments, the data diagram 400 includes a first resource entity 410 (e.g., a project, a file, a folder, a dataset, a data source, etc.), a second resource entity 420, one or more third resource entities 430, a first access entity 420 (e.g., a user, a group, an access group, etc.), a second access entity 422, a first permission entity 430 (e.g., a marking, an organization, a permission attribute), and a second permission entity 432. In some embodiments, a permission attribute includes a permission rule, for example, whether a resource is classified. In this example, the first permission entity 430 and the second permission entity 432 are both applied to the first resource entity 410. As an example, the second permission entity 432 is applied to the second resource entity 432 and is not applied to the first resource entity 410. As an example, the first access entity 420 is a member of both the first permission entity 430 and the second permission entity 432, each a control relationship. As an example, the first access entity 420 is permitted to access the first resource entity 410 and has a permission relationship with the first resource entity 410. Further, as an example, since the first access entity 420 has the control relationships with the first and second permission entities 430, 432, the first access entity 420 can access the first resource entity 410.

As an example, the second access entity 422 does not have a control relationship (e.g., not a member) with the first permission entity 430, the second access entity 422 does not have the permission needed to access the first resource entity 410. As an example, the second access entity 422 is permitted to access the second resource entity 412. In some examples, the first permission entity 430 is applied to one or more third resource entities 414.

According to certain embodiments, at process 190, the system generates and/or updates an access graph including one or more nodes representing one or more entities and one or more edges representing one or more relationships. In some embodiments, the one or more nodes include one or more access nodes representing one or more access entities, one or more resource nodes representing one or more resource entities, and/or one or more permission nodes representing one or more permission entities. In certain embodiments, one or more edges including one or more permission edges representing one or more permission relationships, one or more membership edges representing one or more member relationships, and/or one or more control edges representing one or more control relationships. In some embodiments, a permission edge connects an access node and a resource node. In certain embodiments, a membership edge connects two access nodes. In some embodiments, a control edge connects a permission node with an access node and/or a resource node.

According to some embodiments, at process 195, the system causes presenting a representation of the access graph. In some examples, a first node includes a first visual element and a second node includes a second visual element different from the first visual element. For example, the visual element for a user is different from the visual element for an access group. As an example, the visual element for a marking is different from the visual element for an organization. In certain embodiments, the system goes back to process 110 to receive an input associated with the access graph and update the access graph. For example, the input is a selection of one of the one or more entities in the access graph. As an example, the system adds additional entities and relationships in the access graph based on the selected entity.

FIG. 5A is an example user interface showing an example access graph 500A according to certain embodiments of the present disclosure. FIG. 5A is merely an example. One of ordinary skill in the art would recognize many variations, alternatives, and modifications. In some examples, the system receives an indication (e.g., an identifier, a description, a name, etc.) of an access entity 510. In certain examples, the system determines a plurality of permission relationships 540, 542, 544, 546 with a plurality of resource entities 520, 522, 524, 526 respectively. In some examples, the plurality of permission relationships 540, 542, 544, 546 can be of different access control types. For example, the plurality of permission relationships 540, 542, 544, 546 can be of different access control types including role-based access control, attribute-based access controls, and classification-based access controls. In certain examples, the plurality of permission relationships 540, 542, 544, 546 can be of different roles, such as the observer relationship 540, the owner relationship 542, the editor relationship 544, the viewer relationship 546.

In some examples, the access entity 510 has a plurality of member relationships 550, 552 with a plurality of access entities 512, 514 respectively. For example, the plurality of member relationships 550, 552 include a relationship of being a member of the other access entity. As an example, the access entity 512 is an access group and the access entity 514 is a user. In certain examples, the access entity 512 has a member relationship 554 with the access entity 516. For example, the access group 516 is a member of the access group 512. As an example, the user 518 and the user 159 are members, represented by the member relationships 556 and 558, of the access group 516.

In some examples, the one or more resource entities 520 522, 524 526 are applied with one or more permission entities 530, 532, 534, represented by the one or more control relationships 560, 562, 564, 566, 568. For example, the resource entity 520 is applied with (e.g., a member of) the organization 530 and the organization 532. As an example, only members of the organization 530 or the organization 532 can access the resource entity 520. As an example, the permission entity 532 applies to the resource entity 520 and the resource entity 526. For example, the resource entity 526 is applied with, represented by the control relationships 568, 570, the permission entities 532, 534. As an example, the system receives an input associated with the permission entity 534 and determines additional resource entities 528, 529 are applied with the permission entity 534, represented by the control relationships 572, 574.

In some embodiments, the system allows a user to select any node in the graph to show a menu that allows a user to expand to related entities. For example, to know what users have membership in the group, select that group node and expand into the group node's related entities. As an example, the system receives a selection of the node representing the access entity 512 and determines additional relationships associated with the access entity 512, and adds the access entities 516, 518, 519 and the corresponding relationships 554, 556, 558 to the graph. In some embodiments, the user 518 is permitted to access the resource entity 520 implicitly, for example, through one or more levels of inheritance.

FIG. 5B is an example user interface showing an example access graph 500B.

FIG. 5B is merely an example. One of ordinary skill in the art would recognize many variations, alternatives, and modifications. In some examples, the system receives an indication (e.g., an identifier, a description, a name, etc.) of a resource entity 580. In certain examples, the system determines a plurality of control relationships 585B, 586B, 587B, 588B with a plurality of permission entities 585, 586, 587, 588 respectively.

In some examples, the system receives an input associated with the permission entity 585. In certain examples, the system determines a plurality of resource entities 581 and 582 associated with the permission entity 585, represented by the control relationships 581B, 582B (e.g., “Applied”). In some examples, the system determines a plurality of access entities 590, 591, 592, 593, 594 has a respective control relationship with the permission entities represented by the control relationships 590B, 591B, 592B, 593B, 594B. In certain embodiments, the control relationship includes an administrator, an applier, a remover, a member, and/or the like.

In some embodiments, the system uses an artificial intelligence (AI) model (e.g., a language model (LM), a large language model (LLM), etc.) to generate software code (e.g., in a programming language), referred to access control software, for managing access controls, checking access controls, and/or generating explanations of access controls. In certain embodiments, the software code includes the functionality of adding permissions, changing permissions, and/or deleting permissions. In some embodiments, the software code can generate user interfaces presenting an access graph. In certain embodiments, the software code includes the functionality of adding a first access entity (e.g., a user, an access group) to a second access entity as a member, removing a member from an access entity, and/or the like. In some embodiments, the software includes the functionality of applying a permission entity (e.g., a marking entity, an organization entity, etc.) to a resource entity, removing a permission entity from a resource entity, changing a permission entity, creating a permission entity, deleting a permission entity, and/or the like.

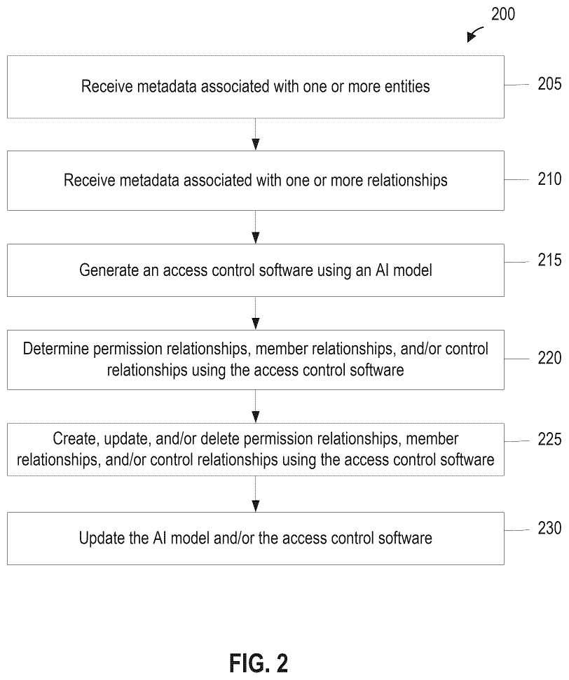

FIG. 2 is a simplified diagram showing a method 200 for generating and/or updating an access management software using an AI model according to certain embodiments of the present disclosure. This diagram is merely an example. One of ordinary skill in the art would recognize many variations, alternatives, and modifications. The method 200 includes processes 205, 210, 215, 220, 225, and 230. Although the above has been shown using a selected group of processes for the method 200, there can be many alternatives, modifications, and variations. For example, some of the processes may be expanded and/or combined. Other processes may be inserted to those noted above. Depending upon the embodiment, the sequence of processes may be changed, and one or more processes may be replaced. Further details of these processes are found throughout the present disclosure.

In some embodiments, some or all processes (e.g., steps) of the method 200 are performed by a system (e.g., the computing system 600). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 205, the system receives metadata associated with one or more entities. In some embodiments, the one or more entities includes one or more access entities, one or more resource entities, and one or more permission entities. In some embodiments, at process 210, the system receives metadata associated with one or more relationships.

In certain embodiments, at process 215, the system generates an access control software using an AI model, referred to as a resource access AI model. In some embodiments, the resource access AI model can be trained using selected corpus (e.g., historical access controls, historical access parameters, historical resource information, historical roles, historical classifications, historical permission attributes, historical markings, historical software code, etc.) and the resource access AI model is configured to generate software code (e.g., software code in python, etc.) for managing and/or checking access.

According to certain embodiments, at process 220, the system determines one or more permission relationships, member relationships, and/or control relationships using the access control software. In some embodiments, at process 225, the system creates, updates, and/or deletes permission relationships, member relationships, and/or control relationships using the access control software. In some embodiments, at process 230, the system updates the AI model and/or the access control software. In some examples, the system updates at least one parameter and/or weight of the AI model based on information of the one or more relationships, information of the one or more entities, and/or metadata associated with the entities and relationships. In certain examples, the system updates the access control software based on information of the one or more relationships, information of the one or more entities, and/or metadata associated with the entities and relationships. In some examples, the system updates the access control software using the AI model (e.g., the updated AI model) based on information of the one or more relationships, information of the one or more entities, and/or metadata associated with the entities and relationships.

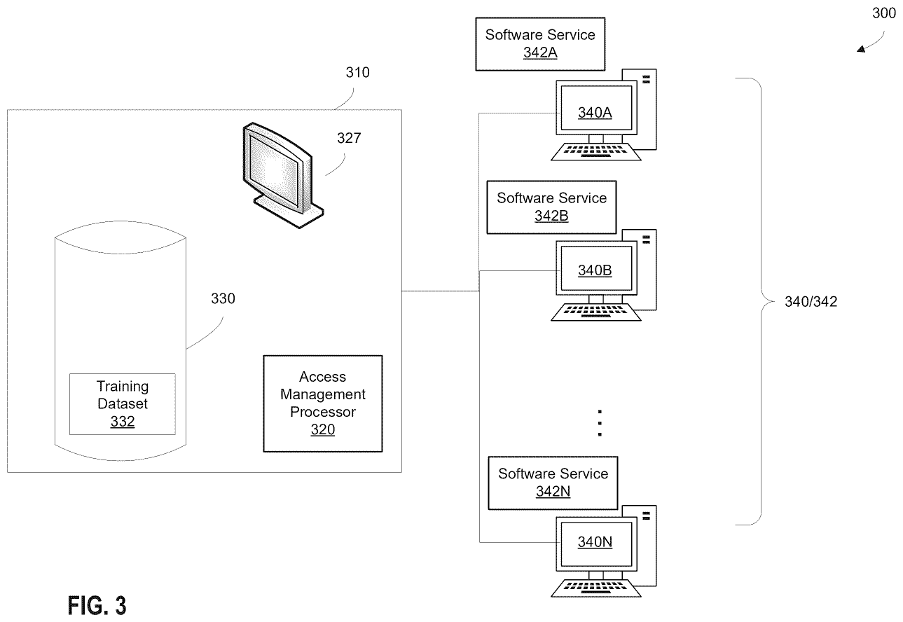

FIG. 3 is an illustrative access management environment 300 according to certain embodiments of the present disclosure. In some embodiments, the access management environment 300 includes one or more access management systems (e.g., access management software modules) 310 and one or more computing devices 340 (e.g., computing device 340A, computing device 340B, . . . computing device 340N, etc.). In certain embodiments, the access management system 310 includes one or more access management processors 320, one or more displays 327, and one or more data repositories 330.

In some embodiments, the one or more data repositories 330 include one or more training datasets 332, for example, for one or more resource access AI models and/or one or more access explanation AI models. In certain embodiments, the computing device 340 may include and/or access at least a part of the functionality of the access management system 310. In some embodiments, the computing device 340 includes one or more entities (e.g., resource entities, access entities, permission entities, etc.) and a corresponding software service 342 (e.g., software service 342A, software service 342B, . . . software service 342N). Although the above has been shown using a selected group of components in the access management environment 300, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to certain embodiments, the access management system 310 (e.g., the access management processor 320, etc.) receives an indication of an entity. In some embodiments, the entity includes an access entity, for example, a user, an administrator, a virtual user, an access group, and/or the like. In certain embodiments, the entity includes a resource entity, for example, a project, a file, a folder, a dataset, and/or the like. In some embodiments, the entity includes a permission entity, for example, an organization, a marking, a permission requirement, and/or the like. FIG. 4 is an illustrative diagram shows the various types of entities. In some embodiments, the entity is to be represented as a node in an access graph. FIGS. 5A and 5B are some examples of access graphs.

In certain embodiments, the indication includes an identifier of the entity, a description of the entity, a name of the entity, and/or the like. In some embodiments, the access management system 310 (e.g., the access management processor 320, etc.) receives an indication of the entity from a user interface. In certain examples, the access management system 310 (e.g., the access management processor 320, etc.) receives an indication of the entity when a user selects to check the user's access graph or another user's access graph. In some examples, the access management system 310 (e.g., the access management processor 320, etc.) receives an indication of the entity from a software interface. In some embodiments, a software interface includes an application programming interface (API), a web service interface, retrieving information from a file, retrieving information from a data repository, and/or the like.

According to some embodiments, the access management system 310 (e.g., the access management processor 320, etc.) determines one or more relationships between two entities. In some embodiments, the one or more relationships include one or more permission relationships, one or more member relationships, one or more permission relationships, and/or the like.

According to certain embodiments, the access management system 310 (e.g., the access management processor 320, etc.) determines one or more permission relationships associated with the entity and one or more resource entities. In certain embodiments, the entity is a first access entity, and the one or more permission relationships include one or more permission relationships between the first access entity and at least one of the one or more resource entities and/or one or more permission relationships associated with the first access entity. In some embodiments, the entity is a first resource entity and the one or more permission relationships include one or more permission relationships associated with the first resource entity. In certain embodiments, the entity is a first permission entity and the one or more permission relationships include one or more permission relationships associated with a resource entity and/or an access entity associated with the In some embodiments, a permission relationship indicates whether an access entity can access a resource entity and what limitation applies (e.g., a role-based limitation). In certain embodiments, the permission relationship can be of different access control types including, for example, a role-based access control (e.g., viewer, editor, etc.), an attribute-based access control (e.g., attributes of the access entity, attributes of the resource entity, etc.), a classification-based access control (e.g., classification of the resource entity), and/or the like. In some embodiments, the permission relationship can be an implicit permission relationship, for example, inherited from an access group. In certain embodiments, the permission relationship is an explicit permission relationship, for example, provided in the entity properties.

According to some embodiments, the access management system 310 (e.g., the access management processor 320, etc.) uses software services 342 to determine the one or more permission relationships. In some embodiments, the access management system 310 (e.g., the access management processor 320, etc.) generates an access inquiry for accessing a respective resource entity and/or a respective access entity. In certain embodiments, the access inquiry includes a resource identifier associated with the respective resource entity and/or an identifier associated with the respective access entity. In some embodiments, the access management system 310 (e.g., the access management processor 320, etc.) sends the access inquiry to a software service corresponding to the respective resource and/or the respective access entity. In certain embodiments, a software service refers to a software module that can run on a computing device. In certain embodiments, the access management system 310 (e.g., the access management processor 320, etc.) receives a permission response from the software service, where the permission response indicates one or more permissions associated with the respective resource entity and/or a respective access entity. In some embodiments, the access management system 310 (e.g., the access management processor 320, etc.) determines one or more permission relationships based on the permission response. In certain embodiments, the access management system 310 (e.g., the access management processor 320, etc.) can conduct processes with the software services repeatedly to determine one or more additional permission relationships associated with other resource entities and/or access entities.

In some embodiments, the one or more permissions are all permissions associated with the respective resource entity (e.g., all access entities that are permitted to access the resource entity explicitly and/or implicitly). In certain embodiments, the one or more permissions are a part of all permissions associated with the respective resource entity. In some embodiments, the access management system 310 (e.g., the access management processor 320, etc.) receives an input indicating one or more criteria (e.g., having a marking), for example, from a user interface and/or a software interface. In certain embodiments, the access management system 310 (e.g., the access management processor 320, etc.) and/or the software service filters all permissions associated with the respective resource entity based on the one or more criteria to generate a set of filtered permission controls. In some embodiments, the input is in natural language and the access management system 310 (e.g., the access management processor 320, etc.) generates one or more filters using a computing model (e.g., an ML model, an AI model, etc.). In some embodiments, the access management system 310 (e.g., the access management processor 320, etc.) uses a language model (e.g., a large language model) to generate the one or more filters (e.g., software code, script, etc.).

In some embodiments, the one or more permissions are all permissions associated with the respective access entity (e.g., all resources permitted to be accessed by the access entity explicitly and/or implicitly). In certain embodiments, the one or more permissions are a part of all permissions associated with the respective access entity. In some embodiments, the access management system 310 (e.g., the access management processor 320, etc.) receives an input indicating one or more criteria (e.g., having a marking), for example, from a user interface and/or a software interface. In certain embodiments, the access management system 310 (e.g., the access management processor 320, etc.) and/or the software service filters all permissions associated with the respective resource entity based on the one or more criteria to generate a set of filtered permission controls. In some embodiments, the input is in natural language and the access management system 310 (e.g., the access management processor 320, etc.) generates one or more filters using a computing model (e.g., an ML model, an AI model, etc.). In some embodiments, the access management system 310 (e.g., the access management processor 320, etc.) uses a language model (e.g., a large language model) to generate the one or more filters (e.g., software code, script, etc.).

According to certain embodiments, the access management system 310 (e.g., the access management processor 320, etc.) determines one or more member relationships associated with the entity and one or more access entities. In certain embodiments, the entity is a first access entity, and the one or more member relationships include one or more member relationships between the first access entity and at least one of the one or more access entities. In some embodiments, the entity is a first resource entity that can be accessed by an access entity and the one or more member relationships include one or more member relationships associated with the access entity. In certain embodiments, the entity is a first permission entity that is associated with an access entity (e.g., a marking role, an organization member, etc.) and the one or more member relationships include one or more member relationships associated with the access entity. In some embodiments, a member relationship indicates a relationship between two access entities including, for example, a member, a child group, a parent group, and/or the like.

According to some embodiments, the access management system 310 (e.g., the access management processor 320, etc.) uses software services 342 to determine the one or more member relationships. In some embodiments, the access management system 310 (e.g., the access management processor 320, etc.) generates a member inquiry associated with a respective access entity. In certain embodiments, the access inquiry includes an identifier associated with the respective access entity. In some embodiments, the access management system 310 (e.g., the access management processor 320, etc.) sends the member inquiry to a software service corresponding to the respective access entity. In certain embodiments, the access management system 310 (e.g., the access management processor 320, etc.) receives a member response from the software service, where the permission response indicates one or more member relationships associated with the respective access entity. In some embodiments, the access management system 310 (e.g., the access management processor 320, etc.) determines one or more member relationships based on the member response. In certain embodiments, the access management system 310 (e.g., the access management processor 320, etc.) can conduct processes associated with the software services 342 repeatedly to determine one or more additional member relationships associated with other access entities.

In some embodiments, the one or more member relationships are all member relationships associated with the respective access entity (e.g., all access entities that are members and/or parents of the access entity). In certain embodiments, the one or more permissions are a part of all member relationships associated with the respective access entity. In some embodiments, the access management system 310 (e.g., the access management processor 320, etc.) receives an input indicating one or more criteria (e.g., having a marking), for example, from a user interface and/or a software interface. In certain embodiments, the access management system 310 (e.g., the access management processor 320, etc.) and/or the software service filters all member relationships associated with the respective access entity based on the one or more criteria to generate a set of filtered member relationships. In some embodiments, the input is in natural language and the access management system 310 (e.g., the access management processor 320, etc.) generates one or more filters using a computing model (e.g., an ML model, an AI model, etc.). In some embodiments, the access management system 310 (e.g., the access management processor 320, etc.) uses a language model (e.g., a large language model) to generate the one or more filters (e.g., software code, script, etc.).

According to certain embodiments, the access management system 310 (e.g., the access management processor 320, etc.) determines one or more control relationships associated with the entity and one or more permission entities. In certain embodiments, the entity is a first access entity, and the one or more control relationships include one or more control relationships between the first access entity and at least one of the one or more permission entities and/or one or more control relationships associated with the first access entity. For example, the one or more control relationships include one or more organization roles (e.g., a member, a non-member, etc.) and/or one or more marking roles (e.g., a member, an applier, an administrator, etc.) of the access entity. In some embodiments, the entity is a first resource entity and the one or more control relationships include one or more control relationships associated with the first resource entity (e.g., marking applied to the resource). In certain embodiments, the entity is a first permission entity and the one or more control relationships include one or more control relationships associated with the first permission entity. In some embodiments, a control relationship indicates whether an access entity has a role with a permission entity, and/or whether a resource entity is applied with the permission entity.

As an example, the first access control type is a role-based access control and the second access control type is an access control inherited from an access group. In certain embodiments, the access management system 310 (e.g., the access management processor 320, etc.) can use a marking to manage resource accesses. In some embodiments, the marking corresponds to at least one selected from a group consisting of a sensitivity level, a training level, a user type, and an organization type. For example, a user may be unable to access resources with a particular marking unless the user has a sensitivity clearance that satisfies the sensitivity level of the particular marking. As an example, a user may be unable to access resources with a particular marking unless the user has certain training that satisfies the training level of the particular marking. As an example, a user may be unable to access resources with a particular marking unless the user has a certain title that satisfies the user type of the particular marking. As an example, a user may be unable to access resources with a particular marking unless the user is part of a certain organization that satisfies the organization type of the particular marking.

According to some embodiments, the access management system 310 (e.g., the access management processor 320, etc.) uses software services 342 to determine the one or more control relationships. In some embodiments, the access management system 310 (e.g., the access management processor 320, etc.) generates a control inquiry associated with a respective permission entity, a respective access entity, and/or a respective resource entity. In certain embodiments, the control inquiry includes a permission identifier associated with the respective permission entity, a resource identifier associated with the respective resource entity, and/or an identifier associated with the respective access entity. In some embodiments, the access management system 310 (e.g., the access management processor 320, etc.) sends the control inquiry to a software service corresponding to the respective permission entity, the respective access entity, and/or the respective resource entity. In certain embodiments, the access management system 310 (e.g., the access management processor 320, etc.) receives a control response from the software service, where the control response indicates one or more control relationships associated with the respective permission entity, the respective access entity, and/or the respective resource entity. In some embodiments, the access management system 310 (e.g., the access management processor 320, etc.) determines one or more control relationships based on the control response. In certain embodiments, the access management system 310 (e.g., the access management processor 320, etc.) can conduct processes associated with the software services 342 repeatedly to determine one or more additional control relationships associated with other permission entities, resource entities and/or access entities.

In some embodiments, the one or more control relationships are all control relationships (e.g., applied resource entities) associated with the respective permission entity. In certain embodiments, the one or more control relationship are a part of all control relationships associated with the respective permission entity. In some embodiments, the access management system 310 (e.g., the access management processor 320, etc.) receives an input indicating one or more criteria (e.g., having a marking), for example, from a user interface and/or a software interface. In certain embodiments, the access management system 310 (e.g., the access management processor 320, etc.) and/or the software service filters all control relationships associated with the respective permission entity based on the one or more criteria to generate a set of filtered control relationships. In some embodiments, the input is in natural language and the access management system 310 (e.g., the access management processor 320, etc.) generates one or more filters using a computing model (e.g., an ML model, an AI model, etc.). In some embodiments, the access management system 310 (e.g., the access management processor 320, etc.) uses a language model (e.g., a large language model) to generate the one or more filters (e.g., software code, script, etc.).

In some embodiments, the one or more control relationships are all control relationships associated with the respective resource entity (e.g., permission entities applied, markings applied, etc.). In certain embodiments, the one or more control relationship are a part of all control relationships associated with the respective resource entity. In some embodiments, the access management system 310 (e.g., the access management processor 320, etc.) receives an input indicating one or more criteria (e.g., having a marking), for example, from a user interface and/or a software interface. In certain embodiments, the access management system 310 (e.g., the access management processor 320, etc.) and/or the software service filters all control relationships associated with the respective resource entity based on the one or more criteria to generate a set of filtered control relationships. In some embodiments, the input is in natural language and the access management system 310 (e.g., the access management processor 320, etc.) generates one or more filters using a computing model (e.g., an ML model, an AI model, etc.). In some embodiments, the access management system 310 (e.g., the access management processor 320, etc.) uses a language model (e.g., a large language model) to generate the one or more filters (e.g., software code, script, etc.).

In some embodiments, the one or more control relationships are all control relationships associated with the respective access entity (e.g., marking roles, organization relationships, etc.). In certain embodiments, the one or more control relationship are a part of all control relationships associated with the respective access entity. In some embodiments, the access management system 310 (e.g., the access management processor 320, etc.) receives an input indicating one or more criteria (e.g., having a marking), for example, from a user interface and/or a software interface. In certain embodiments, the access management system 310 (e.g., the access management processor 320, etc.) and/or the software service filters all control relationships associated with the respective access entity based on the one or more criteria to generate a set of filtered control relationships. In some embodiments, the input is in natural language and the access management system 310 (e.g., the access management processor 320, etc.) generates one or more filters using a computing model (e.g., an ML model, an AI model, etc.). In some embodiments, the access management system 310 (e.g., the access management processor 320, etc.) uses a language model (e.g., a large language model) to generate the one or more filters (e.g., software code, script, etc.).

According to certain embodiments, one or more access entities have different access levels based on the access graph. For example, a specific access entity is at a first access level (e.g., the primary access entity) for a first access graph, and is at a second access level for a second access graph, where the first access level is different from the second access level. In some embodiments, one or more resource entities have different resource levels based on the access graph. For example, a specific resource entity is at a first resource level (e.g., the primary resource entity) for a first access graph, and is at a second resource level for a second access graph, where the first resource level is different from the second resource level. In certain embodiments, one or more permission entities have different control levels based on the access graph. For example, a specific permission entity is at a first control level (e.g., the primary control entity) for a first access graph, and is at a second control level for a second access graph, where the first control level is different from the second control level.

In some embodiments, using the software services and parallel processing, the access management system 310 (e.g., the access management processor 320, etc.) can efficiently check and present permissions for accessing different data and features within a software platform. Accordingly, in certain embodiments, the access management system 310 (e.g., the access management processor 320, etc.) addresses the problem of managing user permissions and access control in complex, multi-level systems with numerous resources. In such environments, for example, ensuring that users have appropriate access to data and resources while maintaining access control (e.g., permission, security) and compliance with regulatory requirements is a challenging task.

FIG. 4 is an illustrative data diagram 400 of entities and relationships according to certain embodiments of the present disclosure. FIG. 4 is merely an example. One of ordinary skill in the art would recognize many variations, alternatives, and modifications. In some embodiments, the data diagram 400 includes a first resource entity 410 (e.g., a project, a file, a folder, a dataset, a data source, etc.), a second resource entity 420, one or more third resource entities 430, a first access entity 420 (e.g., a user, a group, an access group, etc.), a second access entity 422, a first permission entity 430 (e.g., a marking, an organization, a permission attribute), and a second permission entity 432. In some embodiments, a permission attribute includes a permission rule, for example, whether a resource is classified. In this example, the first permission entity 430 and the second permission entity 432 are both applied to the first resource entity 410. As an example, the second permission entity 432 is applied to the second resource entity 432 and is not applied to the first resource entity 410. As an example, the first access entity 420 is a member of both the first permission entity 430 and the second permission entity 432, each a control relationship. As an example, the first access entity 420 is permitted to access the first resource entity 410 and has a permission relationship with the first resource entity 410. Further, as an example, since the first access entity 420 has the control relationships with the first and second permission entities 430, 432, the first access entity 420 can access the first resource entity 410.

As an example, the second access entity 422 does not have a control relationship (e.g., not a member) with the first permission entity 430, the second access entity 422 does not have the permission needed to access the first resource entity 410. As an example, the second access entity 422 is permitted to access the second resource entity 412. In some examples, the first permission entity 430 is applied to one or more third resource entities 414.

According to certain embodiments, the access management system 310 (e.g., the access management processor 320, etc.) generates and/or updates an access graph including one or more nodes representing one or more entities and one or more edges representing one or more relationships. In some embodiments, the one or more nodes include one or more access nodes representing one or more access entities, one or more resource nodes representing one or more resource entities, and/or one or more permission nodes representing one or more permission entities. In certain embodiments, one or more edges including one or more permission edges representing one or more permission relationships, one or more membership edges representing one or more member relationships, and/or one or more control edges representing one or more control relationships. In some embodiments, a permission edge connects an access node and a resource node. In certain embodiments, a membership edge connects two access nodes. In some embodiments, a control edge connects a permission node with an access node and/or a resource node.

According to some embodiments, the access management system 310 (e.g., the access management processor 320, etc.) causes presenting a representation of the access graph, for example, on the display 327 and/or one or more displays associated with one or more computing devices 340. In some examples, a first node includes a first visual element and a second node includes a second visual element different from the first visual element. For example, the visual element for a user is different from the visual element for an access group. As an example, the visual element for a marking is different from the visual element for an organization. In certain embodiments, the access management system 310 (e.g., the access management processor 320, etc.) goes back to receive an input associated with the access graph and update the access graph. For example, the input is a selection of one of the one or more entities in the access graph. As an example, the access management system 310 (e.g., the access management processor 320, etc.) adds additional entities and relationships in the access graph based on the selected entity.

FIG. 5A is an example user interface showing an example access graph 500A. FIG. 5A is merely an example. One of ordinary skill in the art would recognize many variations, alternatives, and modifications. In some examples, the access management system 310 (e.g., the access management processor 320, etc.) receives an indication (e.g., an identifier, a description, a name, etc.) of an access entity 510. In certain examples, the access management system 310 (e.g., the access management processor 320, etc.) determines a plurality of permission relationships 540, 542, 544, 546 with a plurality of resource entities 520, 522, 524, 526 respectively. In some examples, the plurality of permission relationships 540, 542, 544, 546 can be of different access control types. For example, the plurality of permission relationships 540, 542, 544, 546 can be of different access control types including role-based access control, attribute-based access controls, and classification-based access controls. In certain examples, the plurality of permission relationships 540, 542, 544, 546 can be of different roles, such as the observer relationship 540, the owner relationship 542, the editor relationship 544, the viewer relationship 546.

In some examples, the access entity 510 has a plurality of member relationships 550, 552 with a plurality of access entities 512, 514 respectively. For example, the plurality of member relationships 550, 552 include a relationship of being a member of the other access entity. As an example, the access entity 512 is an access group and the access entity 514 is a user. In certain examples, the access entity 512 has a member relationship 554 with the access entity 516. For example, the access group 516 is a member of the access group 512. As an example, the user 518 and the user 159 are members, represented by the member relationships 556 and 558, of the access group 516.

In some examples, the one or more resource entities 520 522, 524 526 are applied with one or more permission entities 530, 532, 534, represented by the one or more control relationships 560, 562, 564, 566, 568. For example, the resource entity 520 is applied with (e.g., a member of) the organization 530 and the organization 532. As an example, only members of the organization 530 or the organization 532 can access the resource entity 520. As an example, the permission entity 532 applies to the resource entity 520 and the resource entity 526. For example, the resource entity 526 is applied with, represented by the control relationships 568, 570, the permission entities 532, 534. As an example, the access management system 310 (e.g., the access management processor 320, etc.) receives an input associated with the permission entity 534 and determines additional resource entities 528, 529 are applied with the permission entity 534, represented by the control relationships 572, 574.

In some embodiments, the access management system 310 (e.g., the access management processor 320, etc.) allows a user to select any node in the graph to show a menu that allows a user to expand to related entities. For example, to know what users have membership in the group, select that group node and expand into the group node's related entities. As an example, the access management system 310 (e.g., the access management processor 320, etc.) receives a selection of the node representing the access entity 512 and determines additional relationships associated with the access entity 512, and adds the access entities 516, 518, 519 and the corresponding relationships 554, 556, 558 to the graph. In some embodiments, the user 518 is permitted to access the resource entity 520 implicitly, for example, through one or more levels of inheritance.

FIG. 5B is an example user interface showing an example access graph 500B. FIG. 5B is merely an example. One of ordinary skill in the art would recognize many variations, alternatives, and modifications. In some examples, the access management system 310 (e.g., the access management processor 320, etc.) receives an indication (e.g., an identifier, a description, a name, etc.) of a resource entity 580. In certain examples, the access management system 310 (e.g., the access management processor 320, etc.) determines a plurality of control relationships 585B, 586B, 587B, 588B with a plurality of permission entities 585, 586, 587, 588 respectively.

In some examples, the access management system 310 (e.g., the access management processor 320, etc.) receives an input associated with the permission entity 585. In certain examples, the access management system 310 (e.g., the access management processor 320, etc.) determines a plurality of resource entities 581 and 582 associated with the permission entity 585, represented by the control relationships 581B, 582B (e.g., “Applied”). In some examples, the access management system 310 (e.g., the access management processor 320, etc.) determines a plurality of access entities 590, 591, 592, 593, 594 has a respective control relationship with the permission entities represented by the control relationships 590B, 591B, 592B, 593B, 594B. In certain embodiments, the control relationship includes an administrator, an applier, a remover, a member, and/or the like.

In some embodiments, the access management system 310 (e.g., the access management processor 320, etc.) uses an artificial intelligence (AI) model (e.g., a language model (LM), a large language model (LLM), etc.) to generate software code (e.g., in a programming language), referred to access control software, for managing access controls, checking access controls, and/or generating explanations of access controls. In certain embodiments, the access control software includes the functionality of adding permissions, changing permissions, and/or deleting permissions. In some embodiments, the access control software can generate user interfaces presenting an access graph. In certain embodiments, the software code includes the functionality of adding a first access entity (e.g., a user, an access group) to a second access entity as a member, removing a member from an access entity, and/or the like. In some embodiments, the software includes the functionality of applying a permission entity (e.g., a marking entity, an organization entity, etc.) to a resource entity, removing a permission entity from a resource entity, changing a permission entity, creating a permission entity, deleting a permission entity, and/or the like.

In some embodiments, the one or more repositories 330 can include one or more training datasets 332, one or more resource access AI models, one or more parameters and weight values for the one or more resource access AI models, one or more access explanation AI models, data resource information, component information, resource information, access control information, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the access management environment 300 can execute software or firmware stored in non-transitory computer-readable medium to implement various processing steps. Various components and processors of the access management environment 300 can be implemented by one or more computing devices including, but not limited to, circuits, a computer, a cloud-based processing unit, a processor, a processing unit, a microprocessor, a mobile computing device, and/or a tablet computer. In some cases, various components referenced by the access management environment 300 (e.g., the one or more access management systems 310, the one or more access management processors 320, the one or more computing devices 340, the one or more software services 342, etc.) can be implemented on a shared computing device. Alternatively, a component of the operating environment 300 can be implemented on multiple computing devices. In some implementations, various modules and components referenced by the access management environment 300 can be implemented as software, hardware, firmware, or a combination thereof. In some cases, various components referenced by the access management environment 300 can be implemented in software or firmware executed by a computing device.

Various components referenced by access management environment 300 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

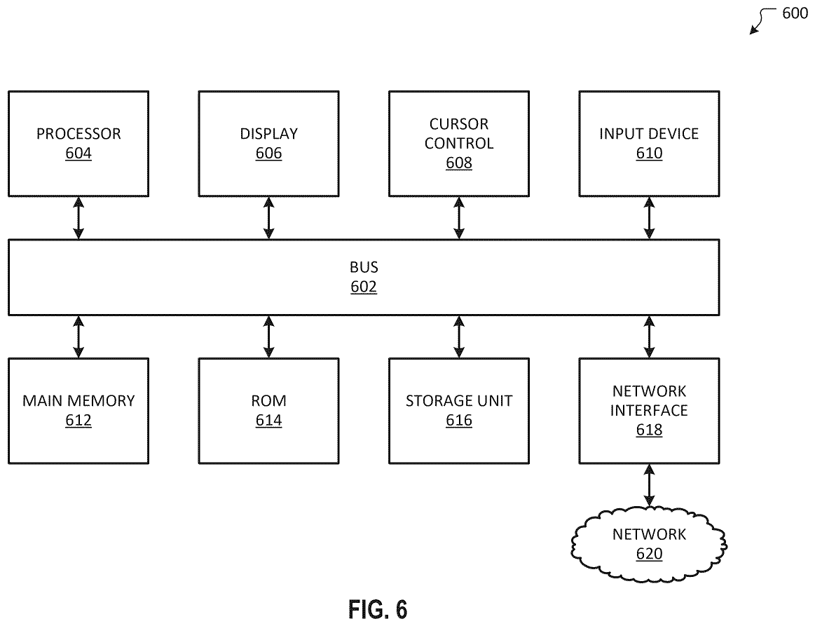

FIG. 6 is a simplified diagram showing a computing system for implementing a system 600 for access management in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the methods (e.g., the method 100, the method 200, etc.) and processes described in the present disclosure are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For example, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for access graphing, the method comprising: receiving an indication of an entity to be represented as a node in an access graph, the entity being associated with one or more resource entities and one or more access entities; determining one or more permission relationships associated with the entity and the one or more resource entities; determining one or more member relationships associated with the entity and the one or more access entities; generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and causing presenting a representation of the access graph; wherein the method is performed by one or more processors. For example, the method is implemented according to at least FIG. 1A, FIG. 1B, FIG. 2, FIG. 3, FIG. 4, FIG. 5A, and/or FIG. 5B.

In some embodiments, the entity is a first access entity at a first access level, wherein at least one of the one or more access entities at a second access level, wherein the at least one of the one or more access entities is associated with the first access entity. In certain embodiments, the second set of edges include a membership edge connecting the first access entity and the at least one of the one or more access entities, wherein the membership edge represents a relationship between the first access entity and the one of the one or more access entities. In some embodiments, the relationship includes at least one selected from a group consist of a member, an administrator, a parent group, and a child group. In certain embodiments, the first set of edges include a permission edge between the first access entity and one of one or more resources, wherein the permission edge represents a role-based access control. In some embodiments, the role-based access control includes at least one selected from a group consisting of a discoverer, a viewer, an editor, and an owner. In certain embodiments, the entity is a permission entity, wherein at least one of the one or more access entities relates to the permission entity via a control relationship.

In some embodiments, the permission entity is an organization entity, wherein the control relationship includes at least one selected from a group consisting of a member, a non-member, and an administrator. In certain embodiments, the permission entity is a marking entity, wherein the marking entity is associated with at least one of the one or more resource entities. In some embodiments, the permission entity is a marking entity, wherein the marking entity is associated with at least one of the one or more access entities, wherein the access graph includes a marking edge representing the marking relationship connect with a marking node representing the marking entity and an access node representing the at least one of the one or more access entities. In certain embodiments, the marking relationship includes at least one selected from a group consisting of an administrator, an applier, a remover, and a member. In some embodiments, the access graph includes a permission node representing a permission entity, wherein the access graph includes a control edge connected to the permission node representing a control relationship.

In certain embodiments, the determining one or more permission relationships associated with the entity and the one or more resource entities includes: generating an access inquiry, the access inquiry including a resource identifier associated with a respective resource entity in the one or more resource entities; sending the access inquiry to a software service corresponding to the respective resource entity; receiving a permission response from the software service, the permission response indicating one or more resource permission relationships associated with the respective resource entity; and determining at least one of the one or more permission relationships associated with the entity based on the permission response.

In certain embodiments, the determining one or more permission relationships associated with the entity and the one or more resource entities includes: generating an access inquiry, the access inquiry including an identifier associated with a respective access entity; sending the access inquiry to a software service corresponding to the respective access entity; receiving a permission response from the software service, the permission response indicating one or more access permission relationships associated with the respective access entity; and determining at least one of the one or more permission relationships associated with the entity based on the permission response.

In some embodiments, the determining one or more member relationships associated with the entity and the one or more access entities includes: generating a member inquiry associated with a respective access entity, the member inquiry including an identifier associated with the respective access entity; sending the member inquiry to a software service corresponding to the respective access entity; receiving a member response from the software service, the member response indicating one or more access member relationships associated with the respective access entity; and determining at least one of the one or more member relationships associated with the entity based on the member response.

In certain embodiments, the method further comprises: determining one or more control relationships associated with the entity. In some embodiments, the determining one or more control relationships includes: generating a control inquiry associated with a respective permission entity, the control inquiry including an identifier associated with the respective permission entity; sending the control inquiry to a software service corresponding to the respective permission entity; receiving a control response from the software service, the control response indicating one or more permission control relationships associated with the respective resource entity; and determining at least one of the one or more control relationships associated with the entity based on the control response. In some embodiments, the method further comprises: receiving a request of changing a permission relationship of the one or more permission relationships associated with the access entity; and changing the permission relationship based on the request; wherein the changing the permission relationship based on the request includes changing the permission relationship using a software code generated by a machine-learning model.

According to some embodiments, a system for access graphing, the system comprising: one or more memories comprising instructions stored thereon; and one or more processors configured to execute the instructions and perform operations comprising: receiving an indication of an entity to be represented as a node in an access graph, the entity being associated with one or more resource entities and one or more access entities; determining one or more permission relationships associated with the entity and the one or more resource entities; determining one or more member relationships associated with the entity and the one or more access entities; generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and causing presenting a representation of the access graph. For example, the system is implemented according to at least FIG. 1A, FIG. 1B, FIG. 2, FIG. 3, FIG. 4, FIG. 5A, and/or FIG. 5B.

In some embodiments, the entity is a first access entity at a first access level, wherein at least one of the one or more access entities at a second access level, wherein the at least one of the one or more access entities is associated with the first access entity. In certain embodiments, the second set of edges include a membership edge connecting the first access entity and the at least one of the one or more access entities, wherein the membership edge represents a relationship between the first access entity and the one of the one or more access entities. In some embodiments, the relationship includes at least one selected from a group consist of a member, an administrator, a parent group, and a child group. In certain embodiments, the first set of edges include a permission edge between the first access entity and one of one or more resources, wherein the permission edge represents a role-based access control. In some embodiments, the role-based access control includes at least one selected from a group consisting of a discoverer, a viewer, an editor, and an owner. In certain embodiments, the entity is a permission entity, wherein at least one of the one or more access entities relates to the permission entity via a control relationship.

In some embodiments, the permission entity is an organization entity, wherein the control relationship includes at least one selected from a group consisting of a member, a non-member, and an administrator. In certain embodiments, the permission entity is a marking entity, wherein the marking entity is associated with at least one of the one or more resource entities. In some embodiments, the permission entity is a marking entity, wherein the marking entity is associated with at least one of the one or more access entities, wherein the access graph includes a marking edge representing the marking relationship connect with a marking node representing the marking entity and an access node representing the at least one of the one or more access entities. In certain embodiments, the marking relationship includes at least one selected from a group consisting of an administrator, an applier, a remover, and a member. In some embodiments, the access graph includes a permission node representing a permission entity, wherein the access graph includes a control edge connected to the permission node representing a control relationship.

In certain embodiments, the determining one or more permission relationships associated with the entity and the one or more resource entities includes: generating an access inquiry, the access inquiry including a resource identifier associated with a respective resource entity in the one or more resource entities; sending the access inquiry to a software service corresponding to the respective resource entity; receiving a permission response from the software service, the permission response indicating one or more resource permission relationships associated with the respective resource entity; and determining at least one of the one or more permission relationships associated with the entity based on the permission response.

In certain embodiments, the determining one or more permission relationships associated with the entity and the one or more resource entities includes: generating an access inquiry, the access inquiry including an identifier associated with a respective access entity; sending the access inquiry to a software service corresponding to the respective access entity; receiving a permission response from the software service, the permission response indicating one or more access permission relationships associated with the respective access entity; and determining at least one of the one or more permission relationships associated with the entity based on the permission response.

In some embodiments, the determining one or more member relationships associated with the entity and the one or more access entities includes: generating a member inquiry associated with a respective access entity, the member inquiry including an identifier associated with the respective access entity; sending the member inquiry to a software service corresponding to the respective access entity; receiving a member response from the software service, the member response indicating one or more access member relationships associated with the respective access entity; and determining at least one of the one or more member relationships associated with the entity based on the member response.

In certain embodiments, the operations further comprise: determining one or more control relationships associated with the entity. In some embodiments, the determining one or more control relationships includes: generating a control inquiry associated with a respective permission entity, the control inquiry including an identifier associated with the respective permission entity; sending the control inquiry to a software service corresponding to the respective permission entity; receiving a control response from the software service, the control response indicating one or more permission control relationships associated with the respective resource entity; and determining at least one of the one or more control relationships associated with the entity based on the control response. In some embodiments, the operations further comprise: receiving a request of changing a permission relationship of the one or more permission relationships associated with the access entity; and changing the permission relationship based on the request; wherein the changing the permission relationship based on the request includes changing the permission relationship using a software code generated by a machine-learning model.

According to certain embodiments, a non-transitory computer-readable storage medium having instructions for access graphing that, when executed by one or more processors, cause the one or more processors to perform operations comprising: receiving an indication of an entity to be represented as a node in an access graph, the entity being associated with one or more resource entities and one or more access entities; determining one or more permission relationships associated with the entity and the one or more resource entities; determining one or more member relationships associated with the entity and the one or more access entities; generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and causing presenting a representation of the access graph. For example, the non-transitory computer-readable storage medium is implemented according to at least FIG. 1A, FIG. 1B, FIG. 2, FIG. 3, FIG. 4, FIG. 5A, and/or FIG. 5B.

In some embodiments, the entity is a first access entity at a first access level, wherein at least one of the one or more access entities at a second access level, wherein the at least one of the one or more access entities is associated with the first access entity. In certain embodiments, the second set of edges include a membership edge connecting the first access entity and the at least one of the one or more access entities, wherein the membership edge represents a relationship between the first access entity and the one of the one or more access entities. In some embodiments, the relationship includes at least one selected from a group consist of a member, an administrator, a parent group, and a child group. In certain embodiments, the first set of edges include a permission edge between the first access entity and one of one or more resources, wherein the permission edge represents a role-based access control. In some embodiments, the role-based access control includes at least one selected from a group consisting of a discoverer, a viewer, an editor, and an owner. In certain embodiments, the entity is a permission entity, wherein at least one of the one or more access entities relates to the permission entity via a control relationship.

In some embodiments, the permission entity is an organization entity, wherein the control relationship includes at least one selected from a group consisting of a member, a non-member, and an administrator. In certain embodiments, the permission entity is a marking entity, wherein the marking entity is associated with at least one of the one or more resource entities. In some embodiments, the permission entity is a marking entity, wherein the marking entity is associated with at least one of the one or more access entities, wherein the access graph includes a marking edge representing the marking relationship connect with a marking node representing the marking entity and an access node representing the at least one of the one or more access entities. In certain embodiments, the marking relationship includes at least one selected from a group consisting of an administrator, an applier, a remover, and a member. In some embodiments, the access graph includes a permission node representing a permission entity, wherein the access graph includes a control edge connected to the permission node representing a control relationship.

In certain embodiments, the determining one or more permission relationships associated with the entity and the one or more resource entities includes: generating an access inquiry, the access inquiry including a resource identifier associated with a respective resource entity in the one or more resource entities; sending the access inquiry to a software service corresponding to the respective resource entity; receiving a permission response from the software service, the permission response indicating one or more resource permission relationships associated with the respective resource entity; and determining at least one of the one or more permission relationships associated with the entity based on the permission response.

In certain embodiments, the determining one or more permission relationships associated with the entity and the one or more resource entities includes: generating an access inquiry, the access inquiry including an identifier associated with a respective access entity; sending the access inquiry to a software service corresponding to the respective access entity; receiving a permission response from the software service, the permission response indicating one or more access permission relationships associated with the respective access entity; and determining at least one of the one or more permission relationships associated with the entity based on the permission response.

In some embodiments, the determining one or more member relationships associated with the entity and the one or more access entities includes: generating a member inquiry associated with a respective access entity, the member inquiry including an identifier associated with the respective access entity; sending the member inquiry to a software service corresponding to the respective access entity; receiving a member response from the software service, the member response indicating one or more access member relationships associated with the respective access entity; and determining at least one of the one or more member relationships associated with the entity based on the member response.

In certain embodiments, the operations further comprise: determining one or more control relationships associated with the entity. In some embodiments, the determining one or more control relationships includes: generating a control inquiry associated with a respective permission entity, the control inquiry including an identifier associated with the respective permission entity; sending the control inquiry to a software service corresponding to the respective permission entity; receiving a control response from the software service, the control response indicating one or more permission control relationships associated with the respective resource entity; and determining at least one of the one or more control relationships associated with the entity based on the control response. In some embodiments, the operations further comprise: receiving a request of changing a permission relationship of the one or more permission relationships associated with the access entity; and changing the permission relationship based on the request; wherein the changing the permission relationship based on the request includes changing the permission relationship using a software code generated by a machine-learning model.

For example, some or all components referenced by various embodiments of the present disclosure each are, individually and/or in combination with at least another component, implemented using one or more software components, one or more hardware components, and/or one or more combinations of software and hardware components. In another example, some or all components referenced by various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components referenced by the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for access graphing, the method comprising:
receiving an indication of an entity to be represented as a node in an access graph, the entity being associated with one or more resource entities and one or more access entities;
determining one or more permission relationships associated with the entity and the one or more resource entities;
determining one or more member relationships associated with the entity and the one or more access entities;
generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and
causing presenting a representation of the access graph;
wherein the method is performed by one or more processors.

2. The method of claim 1, wherein the entity is a first access entity at a first access level, wherein at least one of the one or more access entities at a second access level, wherein the at least one of the one or more access entities is associated with the first access entity.

3. The method of claim 2, wherein the second set of edges include a membership edge connecting the first access entity and the at least one of the one or more access entities, wherein the membership edge represents a relationship between the first access entity and the one of the one or more access entities.

4. The method of claim 3, wherein the relationship includes at least one selected from a group consist of a member, an administrator, a parent group, and a child group.

5. The method of claim 2, wherein the first set of edges include a permission edge between the first access entity and one of one or more resources, wherein the permission edge represents a role-based access control.

6. The method of claim 5, wherein the role-based access control includes at least one selected from a group consisting of a discoverer, a viewer, an editor, and an owner.

7. The method of claim 1, wherein the entity is a permission entity, wherein at least one of the one or more access entities relates to the permission entity via a control relationship.

8. The method of claim 7, wherein the permission entity is an organization entity, wherein the control relationship includes at least one selected from a group consisting of a member, a non-member, and an administrator.

9. The method of claim 8, wherein the permission entity is a marking entity, wherein the marking entity is associated with at least one of the one or more resource entities.

10. The method of claim 8, wherein the permission entity is a marking entity, wherein the marking entity is associated with at least one of the one or more access entities, wherein the access graph includes a marking edge representing a marking relationship connect with a marking node representing the marking entity and an access node representing the at least one of the one or more access entities.

11. The method of claim 10, wherein the marking relationship includes at least one selected from a group consisting of a marking administrator, an applier, a remover, and a member.

12. The method of claim 1, wherein the access graph includes a permission node representing a permission entity, wherein the access graph includes a control edge connected to the permission node representing a control relationship.

13. The method of claim 1, wherein the determining one or more permission relationships associated with the entity and the one or more resource entities includes:
generating an access inquiry, the access inquiry including a resource identifier associated with a respective resource entity in the one or more resource entities;
sending the access inquiry to a software service corresponding to the respective resource entity;
receiving a permission response from the software service, the permission response indicating one or more resource permission relationships associated with the respective resource entity; and
determining at least one of the one or more permission relationships associated with the entity based on the permission response.

14. The method of claim 1, wherein the determining one or more permission relationships associated with the entity and the one or more resource entities includes:
generating an access inquiry, the access inquiry including an identifier associated with a respective access entity;
sending the access inquiry to a software service corresponding to the respective access entity;
receiving a permission response from the software service, the permission response indicating one or more access permission relationships associated with the respective access entity; and
determining at least one of the one or more permission relationships associated with the entity based on the permission response.

15. The method of claim 1, wherein the determining one or more member relationships associated with the entity and the one or more access entities includes:
generating a member inquiry associated with a respective access entity, the member inquiry including an identifier associated with the respective access entity;
sending the member inquiry to a software service corresponding to the respective access entity;
receiving a member response from the software service, the member response indicating one or more access member relationships associated with the respective access entity; and
determining at least one of the one or more member relationships associated with the entity based on the member response.

16. The method of claim 1, further comprising:
determining one or more control relationships associated with the entity.

17. The method of claim 16, wherein the determining one or more control relationships includes:
generating a control inquiry associated with a respective permission entity, the control inquiry including an identifier associated with the respective permission entity;
sending the control inquiry to a software service corresponding to the respective permission entity;
receiving a control response from the software service, the control response indicating one or more permission control relationships associated with the respective resource entity; and
determining at least one of the one or more control relationships associated with the entity based on the control response.

18. The method of claim 1, further comprising:
receiving a request of changing a permission relationship of the one or more permission relationships associated with the access entity; and
changing the permission relationship based on the request;
wherein the changing the permission relationship based on the request includes changing the permission relationship using a software code generated by a machine-learning model.

19. A system for access graphing, the system comprising:
one or more memories comprising instructions stored thereon; and
one or more processors configured to execute the instructions and perform operations comprising:
receiving an indication of an entity to be represented as a node in an access graph, the entity being associated with one or more resource entities and one or more access entities;
determining one or more permission relationships associated with the entity and the one or more resource entities;
determining one or more member relationships associated with the entity and the one or more access entities;
generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and
causing presenting a representation of the access graph.

20. A non-transitory computer-readable storage medium having instructions for access graphing that, when executed by one or more processors, cause the one or more processors to perform operations comprising:
receiving an indication of an entity to be represented as a node in an access graph, the entity being associated with one or more resource entities and one or more access entities;
determining one or more permission relationships associated with the entity and the one or more resource entities;
determining one or more member relationships associated with the entity and the one or more access entities;
generating the access graph representing the one or more permission relationships and the one or more member relationships, the access graph including a first set of nodes representing the one or more resource entities and a second set of nodes representing the one or more access entities, the access graph further including a first set of edges representing the one or more permission relationships connected to the first set of nodes and a second set of edges representing the one or more member relationships connected to the second set of nodes; and
causing presenting a representation of the access graph.
